(19) United States
(12) Patent Application Publication
(10) Pub. No.: US 2020/0170205 A1
(43) Pub. Date: Jun. 4, 2020

(54) Indoor Plant Growing System

(71) Applicants: Itay Tayas Zamir, Herzeliya (IL); Gal Pridan, Herzeliya (IL)

(72) Inventors: Itay Tayas Zamir, Herzeliya (IL); Gal Pridan, Herzeliya (IL)

(21) Appl. No.: 16/207,140

(22) Filed: Dec. 2, 2018

(51) Int. Cl. A01G 31/02; A01G 29/00; A01G 27/00

(52) U.S. Cl. CPC A01G 31/02; A01G 29/00; A01G 22/00; A01G 27/008; A01G 27/001

(57) ABSTRACT

An indoor plant growing system that includes a casing subsystem, a containers chamber, a water containers subsystem, an ultrasonic humidifier, a ventilation system and a lighting system. The casing subsystem includes a roots chamber, a plants chamber and a partition element that separates the roots chamber from the plants chamber. The water containers subsystem includes a humidifying tank, a terminal connection to a main water thank and a water pump that pumps water from the main water thank to the humidifying tank. The ultrasonic humidifier is positioned inside the humidifying tank. The system may include a fertilizer spray system or a cooling system for cooling the water in humidifying tank. The system may include a rotational mechanism which is designed to rotate the casing subsystem so that the plants will grow downward.

### TECHNICAL FIELD

The present invention refers to an indoor plant growing system, which is designed for many kinds of plants, including Hemp for example.

### BACKGROUND ART

Growing plants in general is difficult for an ordinary person who grows the plant when this person is not a professional farmer. Therefore there is a need for a system for cultivating one or few plants, of any kind, that will be small and efficient for a domestic use. The present patent application discloses such system that meets these needs and others as explained in the application.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is an illustrative depiction of the system (1).

FIG. 2 is a schematic depiction of the system (1).

FIG. 3 is a schematic depiction of the water containers subsystem (3).

FIG. 4 is a schematic depiction of the ultrasonic humidifier (4).

FIG. 5 is a schematic depiction of the fertilizer spray system (7).

FIG. 6 is a schematic depiction of the system (1) at roots down state.

FIG. 7 is a schematic depiction of the system (1) at roots up state.

### THE INVENTION

The main object of the present patent application is to provide an indoor plant growing system (1) which is designed to enable users to grow one or few plants inside the house for personal legal use. The indoor plant growing system (1) is mainly designed for growing plants with flowers, but it may be used for other kind of plants. The system (1) is deigned to be relatively small, with low water consumption and without necessity of connection to any water inlet, and by that the user may locate it in his or her house without limitations. When the system is used for growing plants then it serves for all the four stages: the seed stage, the green growth stage, the flowering stage and the drying stage in which the leaves of the plant and its flowers are dried. When the system is used for any other plant that does not have flowers then the fourth stage may not be activated.

The indoor plant growing system (1) includes a casing subsystem (2), a containers chamber (9), a water containers subsystem (3), an ultrasonic humidifier (4), a ventilation system (5), a lighting system (6), and may also include a control unit (8).

The casing subsystem (2) includes a roots chamber (21), a plants chamber (22) and a partition element (23) that substantially separates the roots chamber from the plants chamber. The roots chamber (21) may include a root basket (211) in which the user can plant the seeds or position the roots of the plants. The plants chamber (22) is designed to include the green parts of the plants. The partition element (23) that may be a plate for example is deigned to block mist from moving from the roots chamber to the plants chamber, and by that to save water and energy. The partition element (23) may include a hole (231) through which the stems of the plants pass (hereinafter “stem hole”). In case of a system (1) for growing one or two plants the dimensions of the roots chamber (21) may be about 20 cm height, 10 cm width and 30 cm length, and the plant chamber may be about 40 cm height, 20 cm width and 30 cm length.

The water containers subsystem (3) includes a humidifying tank (31), a terminal connection (32) to a main water thank (33) and a water pump (36) that is designed to pump water from the main water thank (33) into the humidifying tank (31). The water pump (36) pumps water from the main tank to the humidifying tank according to need.

The ultrasonic humidifier (4) is an electronic device that vibrates at an ultrasonic frequency and creates water droplets that silently exit the tank in the form of mist. The ultrasonic humidifier (4) is positioned inside the humidifying tank (31) and is designed to cause the water inside the humidifying tank to release mist to the surrounding air. This mist, which is in fact tiny droplets of water, flows into the roots chamber (21) and irrigate directly the roots (100) of the plants (200).

The humidifying tank (31) together with the ultrasonic humidifier (4) may be positioned inside the roots chamber (21) so that the mist droplets would be in this chamber from the moment they formed. However, it is preferably that the humidifying tank (31) together with the ultrasonic humidifier (4) will be positioned inside the containers chamber (9) nearby outside the roots chamber (21) so that the mist droplets would flow inside the roots chamber through a pipe or a hole for the mist (24) (hereinafter “mist hole”) by a fan element (35) that can be for example a blower. The water containers subsystem (3) including all its parts may be positioned inside the containers chamber (9).

The fact that the mist is streamed directly to the root chamber (21) from the humidifying tank (31) through the mist hole (231) and does not evaporate in the air outside it makes the system a water-efficient system. This saving is not only expressed in the water itself, but in the fertilizer, they contain, in case the water contains fertilizer, saving the operation of the ultrasonic and saving the need to cool the water in the humidifying tank (31) as will explained further.

It is preferably that the ultrasonic humidifier (4) will be regularly immersed inside the water at the humidifying tank (31) at a depth of about one and half centimeter. For achieving that, it is possible to use a floater (41) under which the ultrasonic humidifier (4) will be connected in such a way that it will be located at a depth of one and a half centimeters. Alternatively, it is possible to fix the ultrasonic humidifier (4) to the humidifying tank (31) and ensure that the water level will be about one and a half centimeters above the location of the ultrasonic humidifier (4).

When the system (1) is designed for growing one or two plants then the volume of water needed for the whole process is about 20 litters and therefore the main water tank (33) may be of 20 litters. On the other hand, the volume of the humidifying tank (31) may be relatively small, and by that increasing the efficiency of the ultrasonic humidifier (4). Also, there will be no need to cool a big volume of water but only the water inside the humidifying tank (31) in cases when the water includes the fertilizers.

Using a closed roots chamber (21) makes the system efficient due to the fact that almost all the mist is used without wastefulness. In addition, a relatively small volume humidifying tank (31) enables the mist creation with relatively less heating of the water, and also enables the cooling of the water faster and easier. These characteristics make the system in general more efficient. The fact that the roots are exposed and the irrigation is directly oriented to the roots make that process more efficient.

The ventilation system (5) includes a filter (51) and a filter pump (52) and it is positioned inside or near the plant chamber (22). The ventilation system (5) is designed to filter the air inside the plant chamber (22) and to clean it by circulation.

The lighting system (6) comprises one or more light bulbs that are positioned inside the plant chamber (22). The lighting system provides light and heat to the plants in all of their growth stages, including the process of drying the flowers by the heat of the lighting system. The lighting system may include several LEDs and reflectors and the temperature of the chambers, mainly the plants chamber, may be controlled by the operation of these bulbs.

The plants need fertilizers that may be supplied to them directly in two alternative ways. In the first option, the system (1) may include a fertilizer spray system (7) which is designed to spray fertilizers directly to the roots. The second option is to mix the water with fertilizers. In the first option, the system (1) includes the fertilizer spray system (7) that includes a fertilizer bottle (71) and a spray mechanism (72) that sprays the fertilizer material directly onto the roots of the plants. The spray mechanism (72) is controlled by the control unit (8). This system keeps the fertilizers concentration more accurately steady; enable more control over dosage given to roots, interchangeable easily if needed for growth period needed elements accuracy. Separating general fluid and fertilizer keeps them from early disintegration.

5

In the second option, the water carries the fertilizers. In such case, the water tanks system (3) also includes a cooling system (34) for cooling the water in the humidifying tank (31). It should be understood that the mist creation process by the ultrasonic humidifier (4) heats the water, which is disadvantage when the water includes fertilizers, since the fertilizer is broken down in water, when temperature is above than 20 degrees Celsius. Therefore, the usage of main tank and small tank for the mist creation improves the system. The system (1) includes the cooling system (34) which is designed to cool the water inside the humidifying tank (31) and by that to protect the fertilizers of being broken down. It is easier, faster and more efficient to cool small volume of water inside the humidifying tank (31).

In the germination period, the seeds are inserted in an open special provided box to be inserted to the roots basket (211) and at this stage the system operates the mist creation but without fertilizing. In the drying period at the end of the flowering period, the user may move the control unit (8) to a drying mode, wherein the system stops the watering and fertilizing processes and uses the lights and ventilation, in the proper degree, while in inverted position, to enable suitable environment for drying. After due period flowers are harvested to be stored or consumed.

The system (1) may include a rotational mechanism (91) which is designed to rotate the casing subsystem (2) so that the plant will grow downward. In such case the containers chamber (9) that serves as a base will be in the same position and the casing subsystem (2) may rotates 190 degrees. In this ways, there will be two possible positions: roots-down and roots-up. The roots-down position is in fact the normal way as plants grow. The roots-up position, which is in fact an inverted growth, makes the growing to go along with the gravity. Thus, it makes it more efficient for the plant to ‘invest’ growing efforts in flowering rather than strong structure. In addition, this is the best position for the drying process.

The roots chamber (21) may include a drainage system (212) that may include a drainage pipe (2121) and a drainage pump (2122) to drain the water thickened from the mist. The plants chamber (22) may also include a thermometer sensor. The drainage system (212) fits for both the roots-down and the roots-up positions. In the roots-up position the drainage system (212) should use the drainage pump to take excess water from the roots chamber to the main container.

The rotational mechanism (91) may be for example an axis joint that connects the containers chamber (9) with the casing subsystem (2) that enables a rotation of the casing subsystem (2) relative to the containers chamber (9). Such axis joint may include gears, screws and such mechanisms know in the art that enables a connection with rotational possibility.

The structure of the system as described above and its components makes is possible to build the system in a small compact size for personal use at home that fit for two or few plants and in the concept that all needs for the process are inside the system.

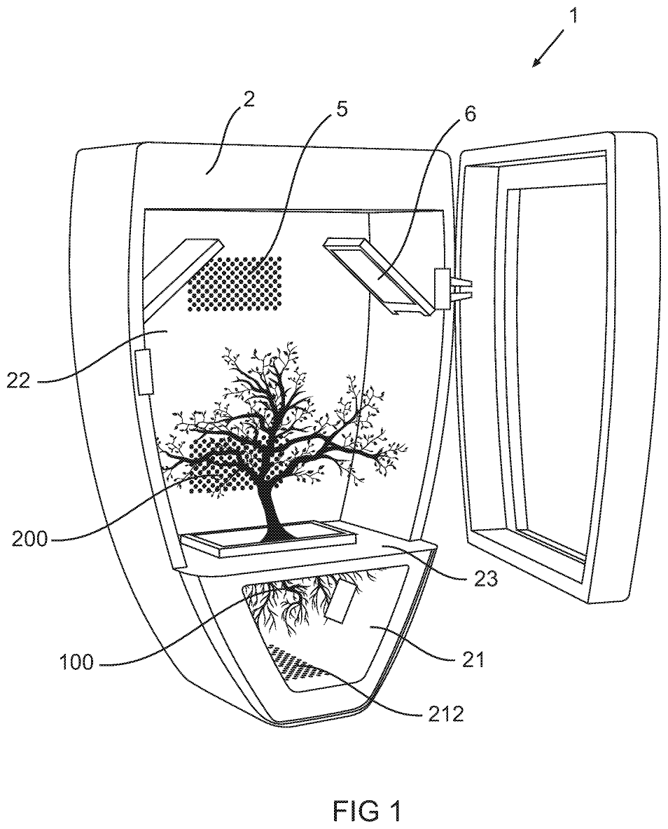

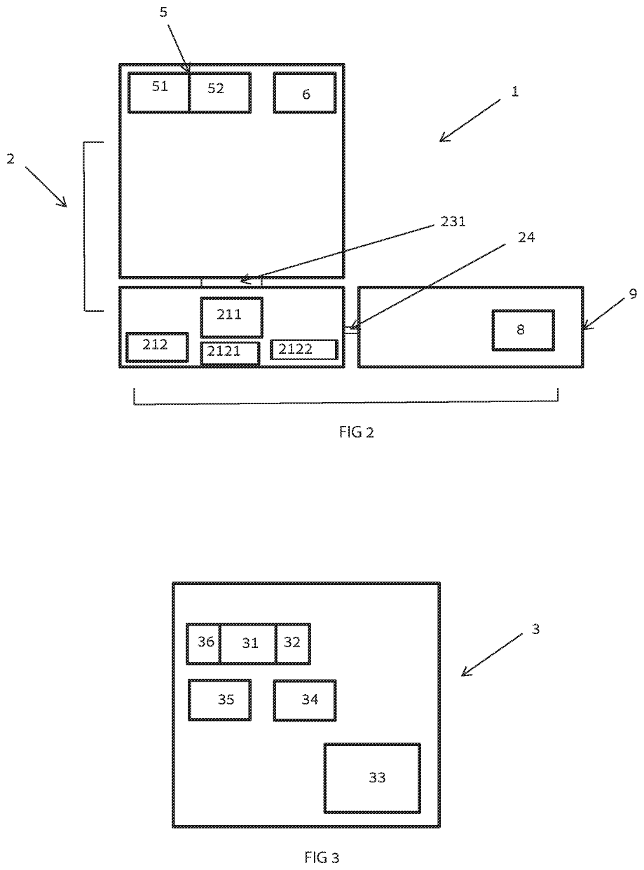

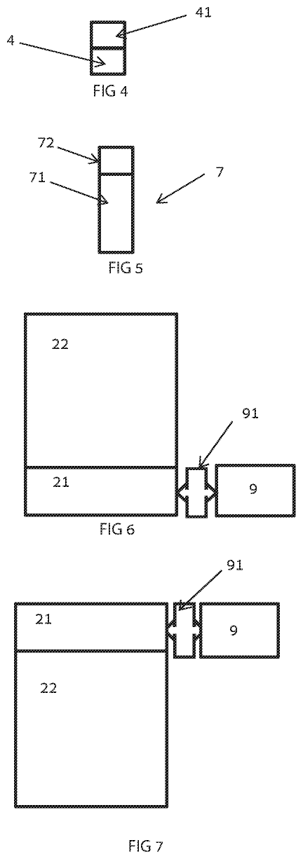

FIG. 1 is an illustrative depiction of the system (1). FIG. 2 is a schematic depiction of the system (1). FIG. 3 is a schematic depiction of the water containers subsystem (3). FIG. 3 is a schematic depiction of the water containers subsystem (3). FIG. 4 is a schematic depiction of the ultrasonic humidifier (4). FIG. 5 is a schematic depiction of the fertilizer spray system (7). FIG. 6 is a schematic depiction of the system (1) at roots down state. FIG. 7 is a schematic depiction of the system (1) at roots up state.

What is claimed is:

1. An indoor plant growing system, comprising: a casing subsystem, a containers chamber, a water containers subsystem, an ultrasonic humidifier, a ventilation system and a lighting system;
wherein the casing subsystem includes a roots chamber, a plants chamber and a partition element that separates the roots chamber from the plants chamber; wherein the partition element is deigned to block mist from moving from the roots chamber to the plants chamber; wherein the partition element includes a hole through which stems of plants can pass;
wherein the water containers subsystem includes a humidifying tank, a terminal connection to a main water thank and a water pump that is designed to pump water from said main water thank to the humidifying tank; wherein the water containers subsystem is positioned inside the containers chamber;
wherein the ultrasonic humidifier is designed to be positioned inside the humidifying tank; wherein the ventilation system includes a filter and a filter pump, said ventilation system is designed to filter air inside the plant chamber; and wherein the lighting system comprises one or more light bulbs that are positioned inside the plant chamber.

2. The indoor plant growing system (1) according to claim 1 that further includes a fertilizer spray system that includes a fertilizer bottle and a spray mechanism that is designed to spray fertilizers from said fertilizer bottle directly onto said roots of said plants.

3. The indoor plant growing system (1) according to claim 1 that further includes a cooling system for cooling water in said humidifying tank.

4. The indoor plant growing system (1) according to claim 1 that further includes a rotational mechanism which is designed to rotate said casing subsystem (2) so that said plants will grow downward.
